(19) United States
(12) Patent Application Publication
(10) Pub. No.: US 2011/0072113 A1
(43) Pub. Date: Mar. 24, 2011

(54) LOCAL SERVER AND CONTENT TRANSMISSION METHOD

(75) Inventor: Satoru GOTO, Ichikawa-shi (JP)

(73) Assignee: Buffalo Inc., Nagoya-shi (JP)

(21) Appl. No.: 12/886,818

(22) Filed: Sep. 21, 2010

(30) Foreign Application Priority Data
Sep. 24, 2009 (JP) 2009-219805

(51) Int. Cl. G06F 15/16

(52) U.S. Cl. 709/218

(57) ABSTRACT

A local server 400 includes a list generator 440 configured to convert a language format compatible with a public server 500 to another language format compatible with a local reproduction device 300. The list generator 440 converts the list of content data stored in the public server 500 to a list of content data written in a language format compatible with the local reproduction device 300. The local server 400 transmits the resultant list of content data converted by the list generator 440 to the local reproduction device 300.

### CROSS REFERENCE TO RELATED APPLICATION

This application is based upon and claims the benefit of priority from the prior Japanese Patent Application No. 2009-219805 filed on Sep. 24, 2009; the entire contents of which are incorporated herein by reference.

### BACKGROUND OF THE INVENTION

1. Field of the Invention

The present invention relates to a local server connected to a local reproduction device via a local network and connected to a public server via a public network, and relates to a content transmission method.

2. Description of the Related Art

In recent years, technologies aimed to promote utilization of content data such as video and audio data in DLNA (Digital Living Network Alliance) have been under development. For example, studies have been in progress on technologies promoting utilization of content data by transmitting the content data from a local server, so-called DMS (Digital Media Server) to a local reproduction device, so-called DMP (Digital Media Player).

Here, the content transmitted from the local server to the local reproduction device is managed by use of a content list called CDS (Content Directory Service). In the CDS, content is managed in tiers. Users view and listen to desired content using CDS (content list) displayed by the local reproduction device.

### SUMMARY OF THE INVENTION

Content data is also stored in a public server (for example, NAS (Network Attached Storage)) connected to a public network such as the Internet. Users have a need to view and listen to the content downloaded from the public server connected to the public network.

However, in the public network, information including content data is written in a language such as HTML, XML, or JSON, for example. Unfortunately, it is generally assumed that the local reproduction device does not have a function to display the information written in any of these languages.

In such a case, the local reproduction device cannot acquire content data from the public server connected to the public network. In short, users' need is not satisfied.

Thus, the present invention is made in order to solve the problem described above, and it is an object of the present invention to provide a local server and a content transmission method that enables acquisition of content data from a public server connected to a public network.

In an aspect of the present invention, a local server (local server 400) connected to a local reproduction device (local reproduction device 300) via a local network (local network 100) and to a public server (public server 500) via a public network (public network 200), the local server comprising: a local communication unit (local communication unit 410) configured to communicate with the local reproduction device via the local network; a public communication unit (public communication unit 420) configured to communicate with the public server via the public network; and a converter (list generator 440) configured to convert a language format compatible with the public server to another language format compatible with the local reproduction device. The local communication unit receives a list request from the local reproduction device, the list request requesting a list of content data stored in the public server. The public communication unit receives the list of content data stored in the public server from the public server in response to the list request. The converter converts the list of content data stored in the public server to a list of content data written in a language format compatible with the local reproduction device. The local communication unit transmits the resultant list of content data converted by the converter to the local reproduction device.

In aforementioned aspect, the local communication unit receives a content data request from the local reproduction device, the content data request requesting content data selected from the resultant list of content data converted by the converter. The public communication unit receives content data from the public server in response to the content data request, the content data corresponding to the content data request. The local communication unit transmits the content data received from the public server to the local reproduction device.

In an aspect of the present invention, a content transmission method for a local server (local server 400) to transmit content data stored in a public server (public server 500) to a local reproduction device (local reproduction device 300) connected to the local server via a local network (local network 100), the public server being connected to the local server via a public network (public network 200), the content transmission method comprising the steps of: transmitting (step S101) a list request to the local server by the local reproduction device, the list request requesting a list of content data stored in the public server; receiving (steps S105, S109) a list of content data from the public server by the local server in response to the list request, the content data being stored in the public server; converting (steps S106, S110) the list of content data stored in the public server to a list of content data written in a language format compatible with the local reproduction device by the local server; and transmitting (step S111) the resultant list of content data converted in the step of converting to the local reproduction device by the local server.

### BRIEF DESCRIPTION OF THE DRAWINGS

FIG. 1 is a diagram showing a content transmission system according to a first embodiment.

FIG. 2 is a diagram showing a local reproduction device according to the first embodiment.

FIG. 3 is a diagram showing a local server according to the first embodiment.

FIG. 4 is a diagram showing an example of a configuration of a content list according to the first embodiment.

FIG. 5 is a diagram showing a generation process of the content list according to the first embodiment (#1).

FIG. 6 is a diagram showing the generation process of the content list according to the first embodiment (#2).

FIG. 7 is a diagram showing the generation process of the content list according to the first embodiment (#3). FIG. 8 is a diagram showing the generation process of the content list according to the first embodiment (#4).

FIG. 9 is a diagram showing the generation process of the content list according to the first embodiment (#5).

FIG. 10 is a diagram showing a public server according to the first embodiment.

FIG. 11 is a sequence diagram showing operations of the content transmission system according to the first embodiment (generation and transmission of the content list).

FIG. 12 is a sequence diagram showing operations of the content transmission system according to the first embodiment (transmission of local content data).

FIG. 13 is a sequence diagram showing operations of the content transmission system according to the first embodiment (transmission of public content data).

### DESCRIPTION OF EMBODIMENTS

Next, an embodiment of the present invention is described with reference to the drawings. In the following description of the drawings, same or similar components are labeled with the same of similar reference numerals. However, it should be noted that the drawings are schematic, and ratios between dimensions are different from actual ones. Accordingly, specific dimensions should be determined in consideration of the following description. Of course, the drawings include parts between which dimensional relationship and ratios are different from each other.

### First Embodiment

A first embodiment of the present invention is described below with reference to the drawings. Specifically, the followings are described: (1) Schematic Configuration of Content Transmission System, (2) Configuration of Local Reproduction Device, (3) Configuration of Local Server, (4) Configuration of Public Server, (5) Operation of Content Transmission System, and (6) Operations and Effects.

### (1) Schematic Configuration of Content Transmission System

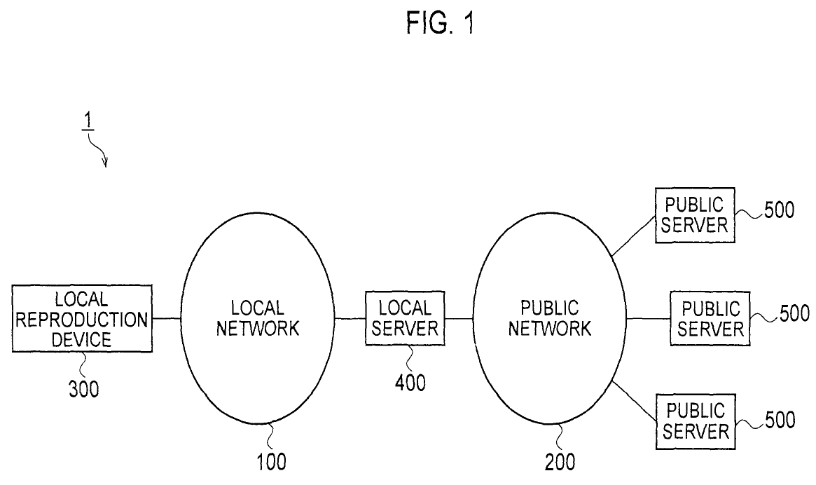

First, a schematic configuration of a content transmission system according to the first embodiment of the present invention is described with reference to FIG. 1. FIG. 1 is a diagram showing a content transmission system 1 according to the first embodiment.

As shown in FIG. 1, the content transmission system 1 includes a local network 100, a public network 200, a local reproduction device 300, a local server 400, and public servers 500.

The content transmission system 1 is a system that transmits the local content data and the public content data to the local reproduction device 300 where the local content data is the content data stored in the local server 400, and the public content data is the content data stored in the public servers 500.

The local network 100 is a network such as a LAN or a wireless LAN. The local network 100 is provided independently from the public network 200.

The public network 200 is a network such as the Internet, for example.

The local reproduction device 300 is a device that is connected to the local network 100 and reproduces e.g., video or audio content data.

Specifically, the local reproduction device 300 receives a content data list (hereinafter referred to as a content list) from the local server 400 via the local network 100. The local reproduction device 300 transmits a content data request requesting content data selected from the received content list, to the local server 400 via the local network 100. The local reproduction device 300 receives content data transmitted in response to the content data request via the local network 100. The local reproduction device 300 reproduces the received content data.

The local server 400 is a server that is connected to the local reproduction device 300 via the local network 100, as well as to the public servers 500 via the public network 200. The local server 400 serves as a content server that provides the local reproduction device 300 with the local content data stored in itself, and also serves as a gateway between the local network 100 and public network 200.

The local server 400 generates a content list that has a language format compatible with the local reproduction device 300, and transmits the generated content list to the local reproduction device 300. The local server 400 receives a content data request from the local reproduction device 300 via the local network 100, the content data request requesting content data selected from the content list.

When the received content data request indicates a request to the local content data, the local server 400 transmits the local content data stored therein to the local reproduction device 300 via the local network 100.

When the content data request received from the local reproduction device 300 indicates a request to the public content data, the local server 400 transfers the received content data request to one of the public servers 500 via the public network 200. In response to the transferred content data request, the local server 400 receives public content data from the public server 500 via the public network 200. The local server 400 transmits the received public content data to the local reproduction device 300 via the local network 100.

The public server 500 is a content server that is connected to the public network 200, and provides the public content data stored in itself. The public server 500 receives a content data request from the local reproduction device 300 via the local network 100 and the public network 200. In response to the received content data request, the public server 500 transmits public content data to the local reproduction device 300 via the public network 200 and the local network 100.

### (2) Configuration of Local Reproduction Device

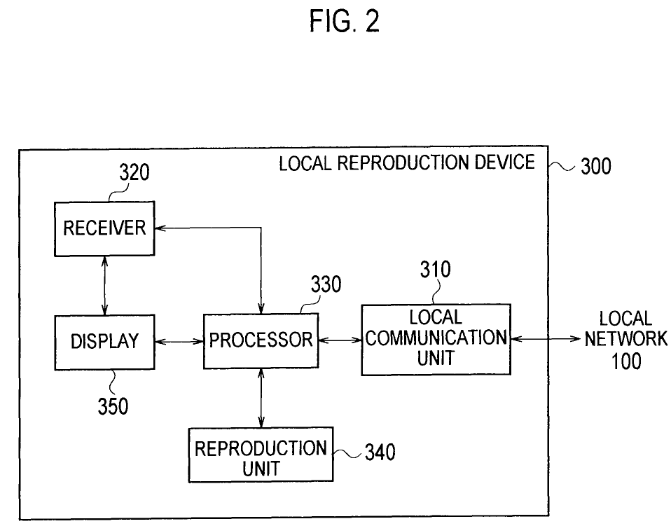

Next, a configuration of a local reproduction device according to the first embodiment of the present invention is described with reference to FIG. 2. FIG. 2 is a diagram showing the local reproduction device 300 according to the first embodiment.

As shown in FIG. 2, the local reproduction device 300 includes a local communication unit 310, a receiver 320, a processor 330, a reproduction unit 340, and a display 350.

The local communication unit 310 is a hardware interface to connect the local reproduction device 300 to the local network 100. For the local communication unit 310, a LAN port or a wireless LAN port may be used.

The receiver 320 receives a request to operate the local reproduction device 300 from the outside of the local reproduction device 300.

The receiver 320 receives, for example, a name assignment request to the public server 500 and a content list acquisition request. The receiver 320 inputs the received request to the processor 330.

The name assignment request to the public server 500 is a request to assign a name to each public server 500 to identify the same, as well as to associate the assigned name with the address of the public server 500 for management in the local server 400. The name assignment request to the public server 500 includes a name assigned by a user of the local reproduction device 300, and the address of the public server 500 as the target to which the name is assigned. The public server name assigned to the public server 500 only needs to be managed in the local reproduction device 300 and the local server 400, and does not need to be notified to the public server 500.

The content list acquisition request is a request to acquire a list of content names assigned to respective pieces of content data stored in a predetermined server. The configuration of the content list is described in detail hereinafter.

The receiver 320 receives information to select item(s) from the content list displayed on the display 350. Specifically, the content list is configured with one or multiple items, and the receiver 320 receives information to select at least one item. The receiver 320, when receiving the information to select item(s), inputs selected item information to the processor 330, the selected item information indicating the selected items.

As the receiver 320, a touch panel or a keyboard that is an operation device operable by a user of the local reproduction device 300, or a radio signal receiver from a remote controller, or a button that can be pressed by a user and arranged on the outer surface of the local reproduction device 300 may be used.

The processor 330 processes a request and information which are acquired from the receiver 320 or the local communication unit 310.

First, the processor 330 acquires a name assignment request to the public server 500 from the receiver 320.

The processor 330 transmits the acquired name assignment request to the local server 400 via the local communication unit 310, the acquired name assignment request being made to the public server 500.

Second, the processor 330 acquires a content list acquisition request from the receiver 320. The processor 330 transmits the acquired content list acquisition request to the local server 400 via the local communication unit 310. In response to the content list acquisition request, the processor 330 receives a content list from the local server 400 via the local communication unit 310. The processor 330 inputs the received content list to the display 350.

Third, the processor 330 acquires selected item information from the receiver 320, the selected item information indicating selected items from the items of the content list displayed on the display 350.

The processor 330 transmits the acquired selected items to the local server 400 via the local communication unit 310. According to the selected items, the processor 330 receives other items included in the content list or content data from the local server 400 via the local communication unit 310. The processor 330, when receiving other items, inputs the received other items to the display 350. The processor 330, when receiving content data, inputs the received content data to the reproduction unit 340.

The reproduction unit 340 performs reproduction processing of the content data acquired from the processor 330. The reproduction unit 340 is configured with, for example, a display that displays a video or data, and/or a speaker that outputs audio.

The display 350 displays the content list acquired from the processor 330. Specifically, the display 350 displays the items of the content list acquired from the processor 330.

Although not shown, the local reproduction device 300 may include a program holder that holds programs for causing a CPU to execute processing of the local communication unit 310, the receiver 320, the processor 330, the reproduction unit 340, and the display 350. As a program holder, a recording media such as a RAM, a ROM, a hard disk, a flexible disk, a compact disc, an IC chip, a cassette tape, and the like, may be used, for example.

### (3) Configuration of Local Server

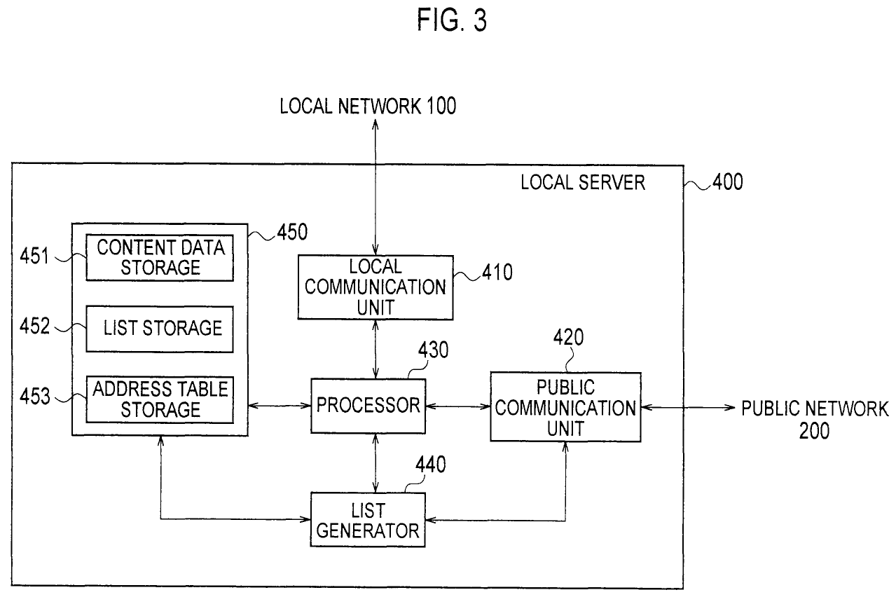

Next, a configuration of a local server according to the first embodiment of the present invention is described with reference to FIGS. 3 to 9.

### (3.1) Schematic Configuration of Local Server

FIG. 3 is a diagram showing the local server 400 according to the first embodiment. As shown in FIG. 3, the local server 400 includes a local communication unit 410, a public communication unit 420, a processor 430, a list generator 440, and a storage 450.

The local communication unit 410 is a hardware interface to connect the local server 400 to the local network 100. As the local communication unit 410, a LAN port or a wireless LAN port may be used.

The public communication unit 420 is an interface to connect the local server 400 to the public network 200.

The processor 430 performs processing in response to a request and selected item information received from the local reproduction device 300 via the local communication unit 410.

The processor 430 acquires e.g., a name assignment request to the public server 500, a content list acquisition request from the local communication unit 410. According to the acquired request, the processor 430 assigns a name to the public server 500, and/or transmits a content list to the local reproduction device 300. The processor 430 also acquires selected item information from the local communication unit 410, the selected item information indicating the items selected from the items of the content list. According to the acquired selected item information, the processor 430 transmits other items or content data.

Specifically, the processor 430, when acquiring a name assignment request to the public server 500, assigns the name included in the name assignment request thereto as a public server name. Specifically, the processor 430 extracts the name included in the name assignment request, as well as the address included in the same. The processor 430 inputs the extracted name as a public server name to the storage 450, as well as the extracted address to the same. After assigning the name to the public server, the processor 430 transmits a name assignment completion notification to the local reproduction device 300 via the local communication unit 410, the name assignment completion notification indicating the completion of assignment of the public server name.

The processor 430, when acquiring a content list acquisition request, inputs a content list generation instruction to the list generator 440, the content list generation instruction instructing generation of a content list. In response to the content list generation instruction, the processor 430 acquires a generation completion notification from the list generator 440, the generation completion notification indicating the completion of generation of the content list. In response to the acquisition of the generation completion notification from the list generator 440, the processor 430 acquires the generated content list from the storage 450. The processor 430 transmits the acquired content list to the local reproduction device 300 via the local communication unit 410. At this point, the processor 430 transmits only a portion of the items of the content list to the local reproduction device 300 as a response to the content list acquisition request. The processor 430 transmits the items other than those transmitted as a response to the content list acquisition request as a response to the selected item information. The processor 430, when acquiring the selected item information, transmits other items included in the content list or content data to the local reproduction device 300 with reference to the content lists stored in the storage 450.

The description of the processing of the processor 430 at the time of transmission of the items or content data of the content list is described in detail hereinafter.

The list generator 440 generates a content list in response to the content list generation instruction acquired from the processor 430. The list generator 440 inputs the generated content list to the storage 450. After inputting the generated content list to the storage 450, the list generator 440 inputs a generation completion notification to the processor 430, the generation completion notification indicating the completion of generation of the content list. The configuration of the list generator 440 is described in detail hereinafter.

The storage 450 is a storage, such as a HDD, that stores predetermined information. As shown in FIG. 3, the storage 450 includes a content data storage 451, a list storage 452, and an address table storage 453.

The content data storage 451 stores local content data. The content data storage 451 stores the local content data and a content name assigned to the local content data with the local content data being associated with the content name.

The list storage 452 stores a content list generated by the list generator 440.

The address table storage 453 stores an address table which associates a public server name assigned by the processor 430 with the address of the public server 500.

Although not shown, the local server 400 may include a program holder that holds a program for causing a CPU to execute processing of the local communication unit 410, the public communication unit 420, the processor 430, the list generator 440, and the storage 450. As a program holder, a recording media such as a RAM, a ROM, a hard disk, a flexible disk, a compact disc, an IC chip, and a cassette tape, and the like, may be used, for example.

### (3.2) Configuration of Content List and Description of Processing by Processor

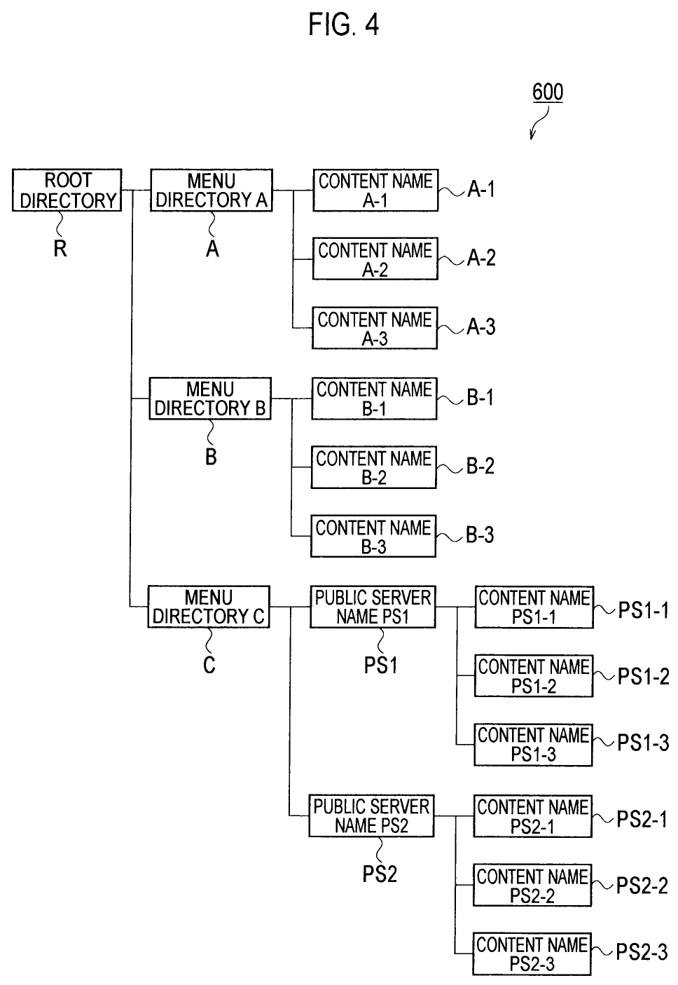

In the following, a configuration of a content list according to the first embodiment of the present invention, and the description of processing of the processor 430 when acquiring selected item information are described with reference to FIG. 4.

The content list has a tree structure in which multiple items are in tiers. Each of the multiple items is classified into two types, i.e., directory name and content name according to the location of the item in the tree structure. Each item located in the bottom tiers of the tree structure represents a content name, and any item other than the one representing a content name represents a directory name.

The processor 430, when acquiring the selected item information, determines the information to be transmitted to the local reproduction device 300 according to the location of the item indicated by the selected item information.

Specifically, when the acquired selected item information matches a directory name, the processor 430 transmits the items located in the immediate lower tier of the matched directory name to the local reproduction device 300.

When the acquired selected item information matches a content name, the processor 430 transmits the content data corresponding to the matched content name to the local reproduction device 300.

When an item indicating a predetermined directory name is located between the item matched with the selected item information and the items in the top tier of the content list, the processor 430 transmits a content data acquisition request to a predetermined public server 500. The content data acquisition request is for acquiring the content data corresponding to the content name. In response to the content data acquisition request, the processor 430 receives the content data corresponding to the content name from the predetermined public server 500, the content name being indicated by the selected item information, and transmits the received content data to the local reproduction device 300. For example, when a directory name indicating the public server name is located in the immediate upper tier of the item matching the selected item information, the processor 430 transmits a content data acquisition request to the public server 500 corresponding to the public server name. The content data acquisition request includes content names.

FIG. 4 is a diagram showing an example of a content list configuration. As shown in FIG. 4, the content list 600 has a tree structure with the root directory being the top tier, and each content name being in the bottom tier.

Root directory R, menu directories A, B, C, content names A-1 to A-3, B-1 to B-3, public server names PS1, PS2, content names PS1-1 to PS1-3, PS2-1 to PS2-3 included in the content list 600 shown in FIG. 4 are collectively referred to as items of the content list.

The root directory R is used to display the menu directories A, B, C. In response to the content list acquisition request, the processor 430 transmits the root directory R to the local reproduction device 300.

The processor 430, when receiving the selected item information indicating the root directory R from the local reproduction device 300, transmits the menu directories A, B, C, i.e. the items located in the immediate lower tier of the root directory R to the local reproduction device 300.

The menu directories A, B, C indicate the types of content which can be provided to the local reproduction device 300 by the local server 400. For example, the menu directory A indicates the provision of the audio content data, the menu directory B indicates the provision of the video content data, and the menu directory C indicates the provision of the content data stored in the public server 500 connected to the public network 200.

The processor 430, when receiving selected item information indicating the menu directory A from the local reproduction device 300, transmits the content names A-1 to A-3, i.e., the items located in the immediate lower tier of the menu directory A to the local reproduction device 300. The processor 430, when receiving selected item information indicating the menu directory B from the local reproduction device 300, transmits the content names B-1 to B-3, i.e., the items located in the immediate lower tier of the menu directory B to the local reproduction device 300. The processor 430, when receiving selected item information indicating the menu directory C from the local reproduction device 300, transmits the public server names PS1, PS2, i.e., the items located in the immediate lower tier of the menu directory C to the local reproduction device 300.

The content names A-1 to A-3 indicate the ones assigned to the local content data that is stored in the storage 450 of the local server 400, and corresponds to the type of content indicated by the menu directory A. For example, when the menu directory A indicates the provision of the audio content data, the content names A-1 to A-3 indicate the content names assigned to audio content data of the local content data that is stored in the storage 450 of the local server 400.

The content names B-1 to B-3 indicate the ones assigned to the local content data that is stored in the storage 450 of the local server 400, and corresponds to the type of content indicated by the menu directory B. For example, when the menu directory B indicates the provision of the video content data, the content names B-1 to B-3 indicate the content names assigned to video content data of the local content data that is stored in the storage 450 of the local server 400.

The processor 430, when receiving selected item information indicating the content names A-1 to A-3, B-1 to B-3, transmits the local content data to the local reproduction device 300, the local content data corresponding to the content name indicated by the selected item information.

The public server names PS1 and PS2 indicate the ones assigned to servers that provide the content data other than the local content data stored in the storage 450 of the local server 400. For example, when the menu directory C indicates the provision of the content data stored in the public server 500 connected to the public network 200, the public server names PS1 and PS2 indicate the names of public server 500 assigned in the local server 400 according to a name assignment request to the public server 500.

The processor 430, when receiving selected item information indicating the public server name PS1, transmits the content names PS1-1 to PS1-3 to the local reproduction device 300, the content names PS1-1 to PS1-3 being the items located in the immediate lower tier of the public server name PS1. The processor 430, when receiving selected item information indicating the public server name PS2, transmits the content names PS2-1 to PS2-3 to the local reproduction device 300, the content names PS2-1 to PS2-3 being the items located in the immediate lower tier of the public server name PS2.

The content names PS1-1 to PS1-3 are the items located in the immediate lower tier of the public server name PS1. The content names PS1-1 to PS1-3 indicate the ones assigned to the public content data stored in the public server 500 corresponding to the public server name PS1.

The content names PS2-1 to PS2-3 are the items located in the immediate lower tier of the public server name PS2. The content names PS2-1 to PS2-3 indicate the ones assigned to the public content data stored in the public server 500 corresponding to the public server name PS2.

The processor 430, when receiving selected item information indicating the content names PS1-1 to PS1-3, PS2-1 to PS2-3, transmits a content data acquisition request requesting acquisition of the content data corresponding to the content names indicated by the selected item information to the public server 500 corresponding to the public server name located in the immediate upper tier of the content name. The content data acquisition request includes the content names indicated by the selected item information. In response to the content data acquisition request, the processor 430 receives the public content data corresponding to the content names included in the content data acquisition request from the public server 500. The processor 430 transmits the received public content data to the local reproduction device 300.

### (3.3) Configuration of List Generator

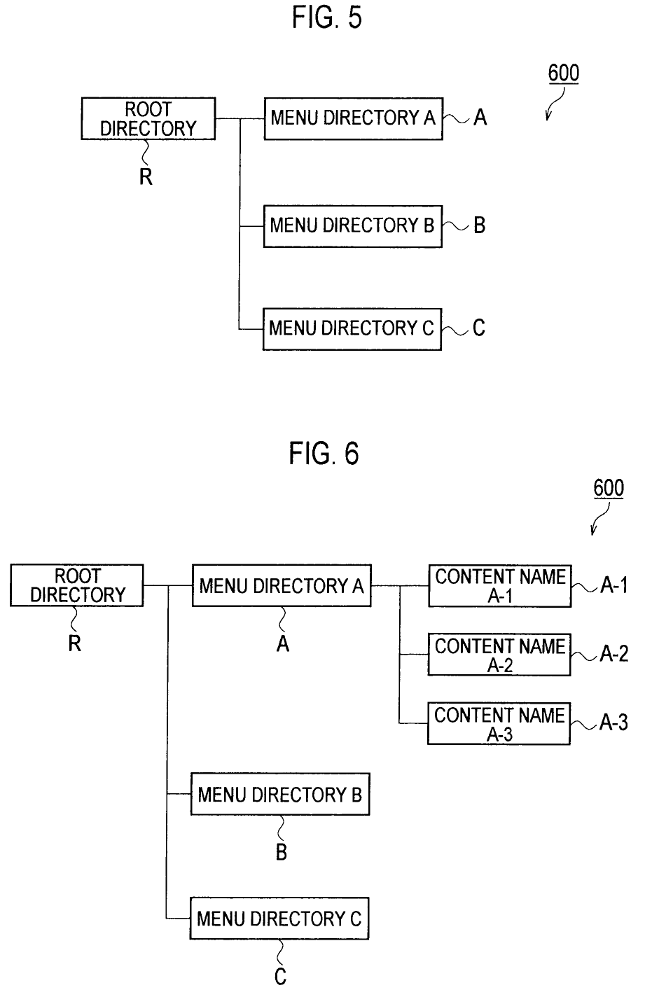

In the following, a configuration of a list generator provided on the local server according to the first embodiment of the present invention is described with reference to FIGS. 5 to 9.

The list generator 440 generates a content list by using the information stored in the storage 450 and the information received from the public server 500 in response to a content list generation instruction acquired from the processor 430. The list generator 440 generates a content list that has the language format compatible with the local reproduction device 300.

FIGS. 5 to 9 are diagrams showing a generation process of a content list by the list generator 440.

First, the list generator 440 generates items in the immediate lower tier of the root directory R. Specifically, as shown in FIG. 5, the list generator 440 places the menu directories A, B, C in the immediate lower tier of the root directory R. As described above, the root directory R is used to display the menu directories A, B, C. The menu directories A, B, C also indicate the types of content that can be provided to the local reproduction device 300 by the local server 400. For example, the menu directory A indicates the provision of the audio content data, the menu directory B indicates the provision of the video content data, and the menu directory C indicates the provision of the content data stored in the public server 500 connected to the public network 200.

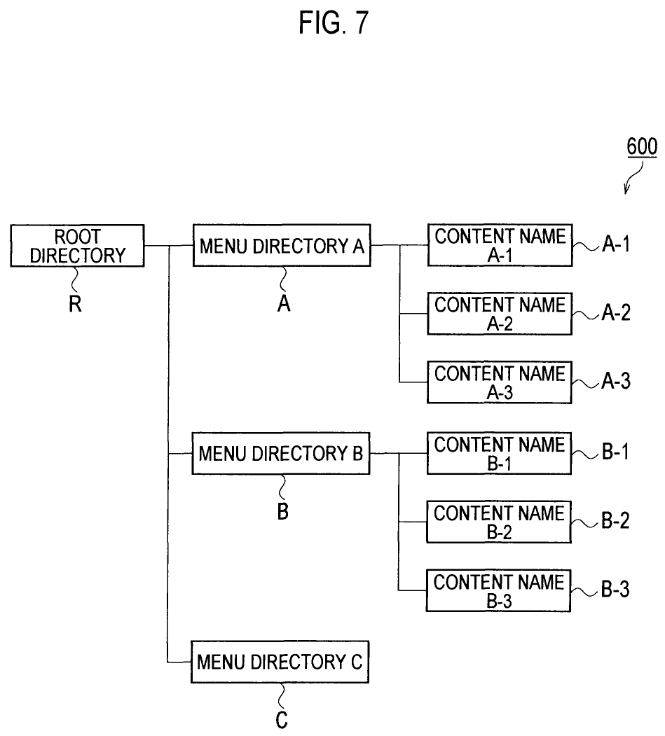

Second, the list generator 440 generates items in the immediate lower tier of the menu directory A with reference to the local content stored in the storage 450. Specifically, as shown in FIG. 6, the list generator 440 acquires the content names assigned to the content data corresponding to the type of content indicated by the menu directory A, and places the acquired content names in the immediate lower tier of the menu directory A. For example, when the menu directory A indicates the provision of the audio content data, the list generator 440 acquires the content names A-1 to A-3 which are assigned to the audio content data in the local content data stored in the storage 450. The list generator 440 then places the acquired content names A-1 to A-3 in the immediate lower tier of the menu directory A.

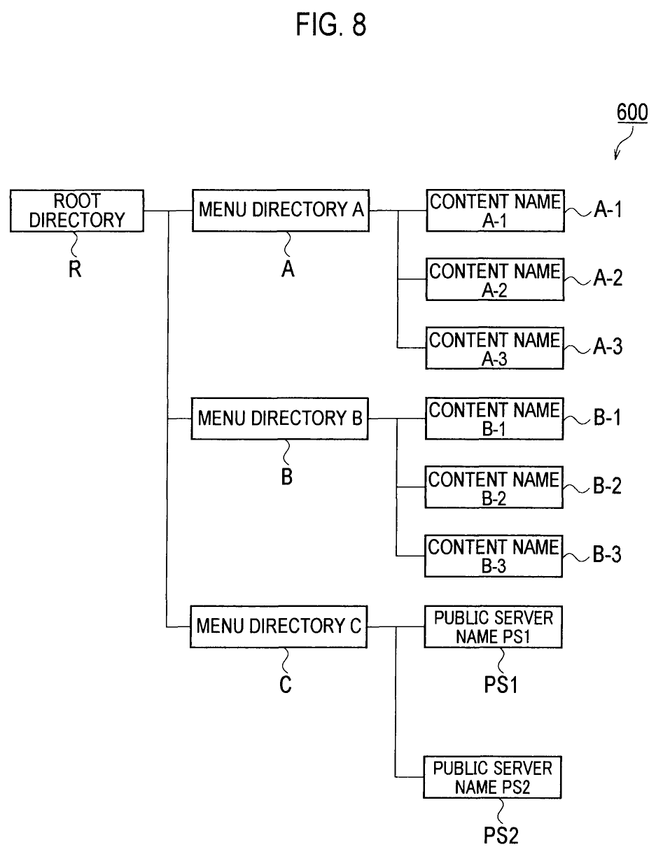

Third, the list generator 440 generates items in the immediate lower tier of the menu directory B with reference to the local content stored in the storage 450. Specifically, as shown in FIG. 7, the list generator 440 acquires the content names assigned to the content data corresponding to the type of content indicated by the menu directory B, and places the acquired content names in the immediate lower tier of the menu directory B. For example, when the menu directory B indicates the provision of the video content data, the list generator 440 acquires the content names B-1 to B-3 which are assigned to the video content data in the local content data stored in the storage 450. The list generator 440 then places the acquired content names B-1 to B-3 in the immediate lower tier of the menu directory B.

Fourth, the list generator 440 generates items in the immediate lower tier of the menu directory C. Specifically, as shown in FIG. 8, the list generator 440 acquires the server names of the servers that store the content data corresponding to the type of content indicated by the menu directory C, and places the acquired public server names in the immediate lower tier of the menu directory C. For example, when the menu directory C indicates the provision of the content data stored in the public server 500 connected to the public network 200, the list generator 440 acquires the public server names PS1 and PS2 set in the local server 400 from the storage 450. The list generator 440 then places the acquired public server name PS1 and PS2 in the immediate lower tier of the menu directory C.

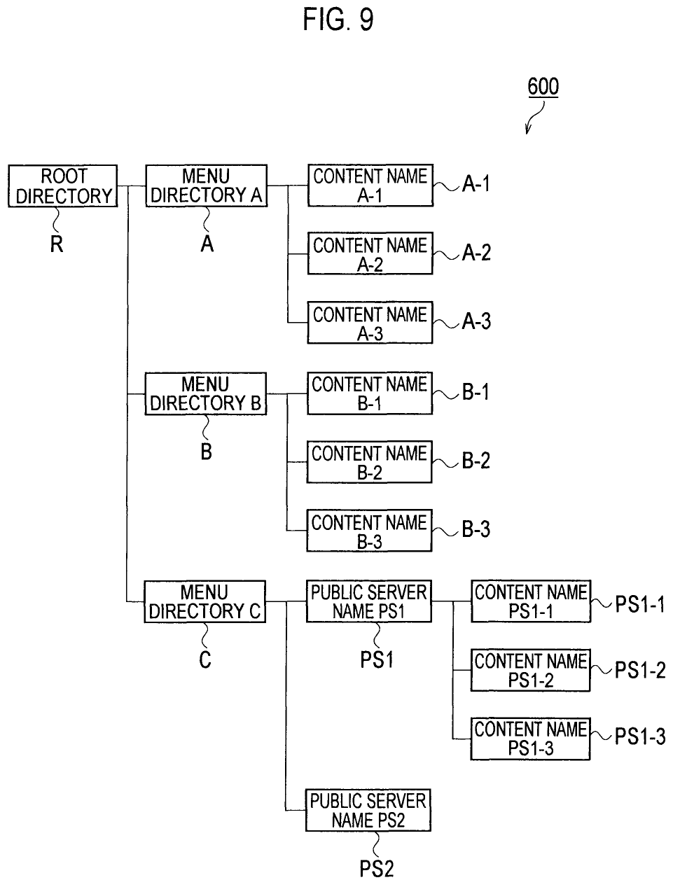

Fifth, as shown in FIG. 9, the list generator 440 generates items in the immediate lower tier of the public server name PS1.

Specifically, first, the list generator 440 acquires the address corresponding to the public server name PS1 with reference to the address table stored in the storage 450. Next, by using the acquired address, the list generator 440 transmits a public content list acquisition request to the public server 500 via the public communication unit 420. The public content list acquisition request is for acquiring the list of the public content stored in the public server 500 corresponding to the public server name PS1.

The list generator 440 receives a public content list from the public server 500, the public content list being the list of the public content stored in the public server 500.

Here, the received public content list is written in a language format such as HTML, XML, or JSON, for example, compatible with the public server 500. Then, the list generator 440 extracts content names assigned to the public content data from the received public content list. The list generator 440 places the extracted content names in parallel as the items in the immediate lower tier of the public server name PS1. Accordingly, the language format of the public content list stored in the public server 500 is converted to a language format compatible with the local reproduction device 300, and the public content list stored in the public server 500 is incorporated into a part of the content list having the language format compatible with the local reproduction device 300. That is, the list generator 440 serves as a converter that converts the language format compatible with the public server 500 to the language format compatible with the local reproduction device 300.

Items in the immediate lower tier of the public server name PS2 is generated in a similar manner to that of the public server name PS1, thus the description of the generation is omitted.

### (4) Configuration of Public Server

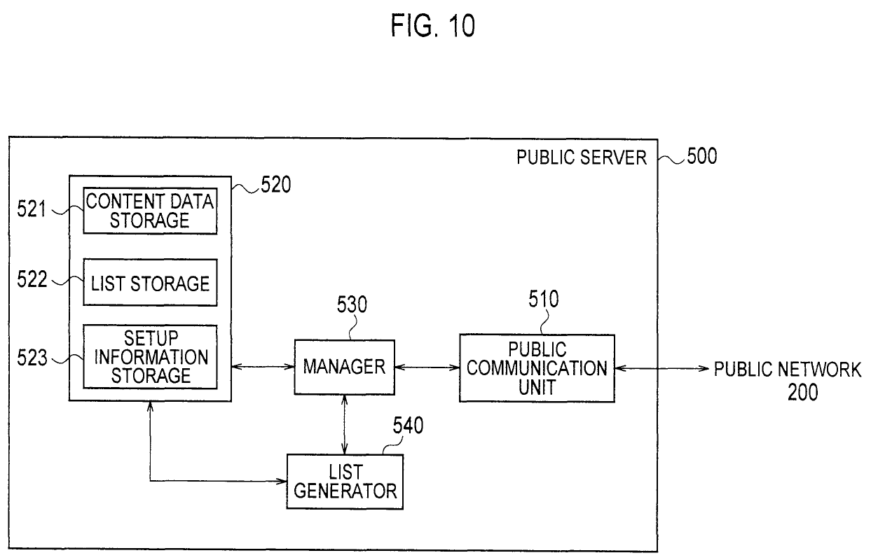

Next, a configuration of a public server according to the first embodiment of the present invention is described with reference to FIG. 10. FIG. 10 is a diagram showing the public server 500 according to the first embodiment.

As shown in FIG. 10, the public server 500 includes a public communication unit 510, a storage 520, a manager 530, and a list generator 540.

The public communication unit 510 is an interface to connect the public server 500 to the public network 200.

The storage 520 is a storage such as a HDD that stores predetermined information. As shown in FIG. 10, the storage 520 has a content data storage 521, a list storage 522, and a setup information storage 523.

The content data storage 521 stores public content data. The content data storage 521 stores the public content data and a content name assigned to the public content data with the public content data being associated with the content name.

The list storage 522 stores content lists generated by the list generator 540.

The setup information storage 523 stores information set in the public server 500. The setup information storage 523 stores e.g., an identifier that identifies the public server 500, and the address of the public server 500 as the information set in the public server 500.

The manager 530 manages the information stored in the storage 520 in response to a request received from the local server 400 via the public communication unit 510. The manager 530 acquires e.g., a public content list acquisition request and a content data acquisition request from the public communication unit 510.

The manager 530, when acquiring a public content list acquisition request, inputs an instruction for generating a public content list to the list generator 540, the public content list including the content names of the public content data stored in the storage 520. In response to a public content list generation instruction, the manager 530 acquires a generation completion notification from the list generator 540, the generation completion notification indicating the completion of generation of the public content list. In response to the acquisition of the generation completion notification from the list generator 540, the manager 530 acquires the generated public content list from the storage 520. The manager 530 transmits the acquired content list to the local server 400 via the public communication unit 510.

The manager 530, when acquiring a content data acquisition request, acquires the public content data corresponding to the content name included in the content data acquisition request from the storage 520. The manager 530 transmits the acquired public content data to the local server 400 via the public communication unit 510. The public content data transmitted to the local server 400 is transferred to the local reproduction device 300 by the local server 400.

The list generator 540 generates a public content list including the content names of the public content data in response to the public content list generation instruction acquired from the manager 530. The list generator 540 generates a public content list having the language format compatible with the public server 500. Such public content list is written in a language such as HTML, XML, or JSON, for example.

The list generator 540 inputs the generated list to the storage 520, and inputs a generation completion notification to the manager 530, the generation completion notification indicating the completion of generation of the list.

Although not shown, the public server 500 may include a program holder that holds a program for causing a CPU to execute processing of the public communication unit 510, the storage 520, the manager 530, and the list generator 540. As a program holder, a recording media such as a RAM, a ROM, a hard disk, a flexible disk, a compact disc, an IC chip, and a cassette tape, and the like, may be used, for example.

### (5) Operations of Content Transmission System

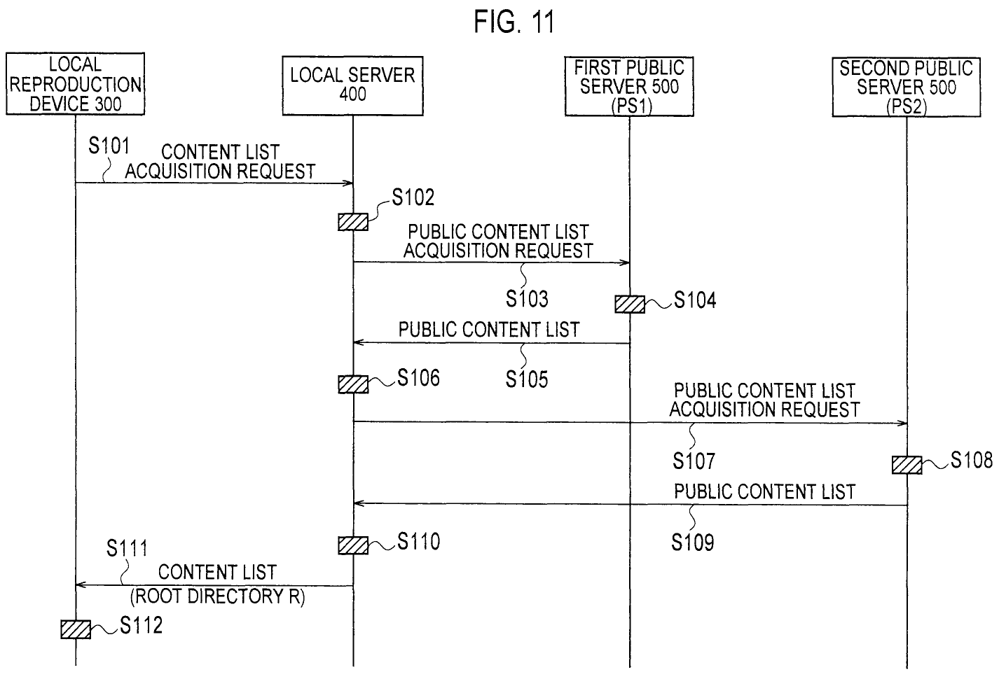

In the following, operations of the content transmission system according to the first embodiment of the present invention are described with reference to FIGS. 11 to 13. In the following, the case where the public server names PS1 and PS2 are already assigned to the public server names of a first and a second public servers 500, respectively, in the local server 400 is described. In the following, the case where the content list shown in FIG. 4 is generated as a content list is described.

### (5.1) Generation and Transmission of Content List

First, operations of the content transmission system 1 in the case where a content list is transmitted to the local reproduction device 300 in response to a content list acquisition request are described with reference to FIG. 11. FIG. 11 is a sequence diagram showing operations of the content transmission system 1 in the case where a content list is generated in response to a content list acquisition request and the generated content list is transmitted to the local reproduction device 300.

As shown in FIG. 11, in step S101, the local reproduction device 300 transmits the content list acquisition request to the local server 400.

In step S102, the local server 400 generates a part of the content list. Specifically, the local server 400 places the menu directories A, B, C in the immediate lower tier of the root directory R. Here, the menu directory A indicates the provision of the audio content data, the menu directory B indicates the provision of the video content data, and the menu directory C indicates the provision of the content data stored in the public server 500 connected to the public network 200. Next, the local server 400 places the content names A-1 to A-3 in the immediate lower tier of the menu directory A, the content names A-1 to A-3 being assigned to the audio content data in the local content data stored in the storage 450. Next, the local server 400 places the content names B-1 to B-3 in the immediate lower tier of the menu directory B, the content names B-1 to B-3 being assigned to the video content data in the local content data stored in the storage 450. Next, the local server 400 places the public server names PS1 and PS2 stored in the storage 450 in the immediate lower tier of the menu directory C.

In step S103, the local server 400 transmits a public content list acquisition request to a first public server 500 corresponding to the public server name PS1.

In step S104, the first public server 500 generates a public content list including the content names of the public content data stored in the first public server 500 itself.

In step S105, the first public server 500 transmits the public content list generated in step S104 to the local server 400.

In step S106, the local server 400 converts the language format of the received public content list. Specifically, the local server 400 extracts the content names of the public content data stored in the first public server 500 from received public content list, and places extracted content names in the immediate lower tier of the public server name PS1.

In step S107, the local server 400 transmits a public content list acquisition request to the second public server 500 corresponding to the public server name PS2.

In step S108, the second public server 500 generates a public content list including the content names of the public content data stored in the second public server 500 itself.

In step S109, the second public server 500 transmits the public content list generated in step S108 to the local server 400.

In step S110, the local server 400 converts the language format of received public content list. Specifically, the local server 400 extracts the content names of the public content data stored in the second public server 500 from received public content list, and places extracted content names in the immediate lower tier of the public server name PS2. The content list is generated by the above steps S102 to S110.

In step S111, the local server 400 transmits generated content list to the local reproduction device 300. Specifically, as a response to the content list acquisition request received in step S101, the local server 400 transmits the root directory R of the items included in the content list to the local reproduction device 300.

In step S112, the local reproduction device 300 displays received root directory R.

### (5.2) Transmission of Local Content

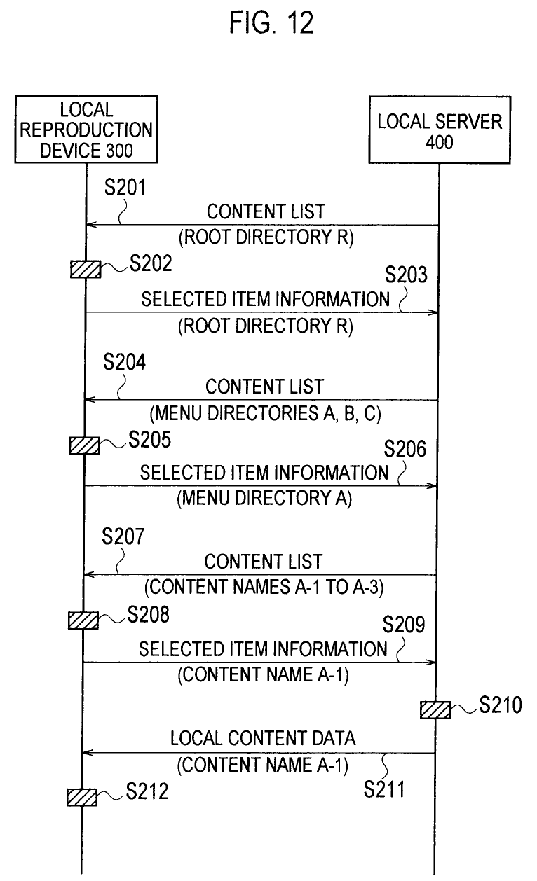

Next, operations of the content transmission system 1 from transmission of a content list to transmission of a local content list are described with reference to FIG. 12. FIG. 12 is a sequence diagram showing operations of the content transmission system 1 in the case where local content data is transmitted.

As shown in FIG. 12, in step S201, the local server 400 transmits a content list to the local reproduction device 300. Specifically, the local server 400 transmits the root directory R of the items included in the content list to the local reproduction device 300.

In step S202, the local reproduction device 300 displays received root directory R.

In step S203, the local reproduction device 300 transmits selected item information indicating the root directory R to the local server 400.

In step S204, the local server 400 transmits the content list to the local reproduction device 300. Specifically, the local server 400 transmits the menu directories A, B, C to the local reproduction device 300, the menu directories A, B, C being the items included in the content list and located in the immediate lower tier of the root directory R indicated by received selected item information.

In step S205, the local reproduction device 300 displays received menu directories A, B, C.

In step S206, the local reproduction device 300 transmits selected item information indicating the menu directory A to the local server 400.

In step S207, the local server 400 transmits the content list to the local reproduction device 300. Specifically, the local server 400 transmits the content names A-1 to A-3 to the local reproduction device 300, the content names A-1 to A-3 being the items included in the content list and located in the immediate lower tier of the menu directory A indicated by received selected item information.

In step S208, the local reproduction device 300 displays received content names A-1 to A-3.

In step S209, the local reproduction device 300 transmits selected item information indicating the content name A-1 to the local server 400.

In step S210, the local server 400 reads content data. Specifically, the local server 400 reads local content data corresponding to the content name A-1 indicated by the received selected item information.

In step S211, the local server 400 transmits the read local content data to the local reproduction device 300.

In step S212, the local reproduction device 300 reproduces received local content data.

### (5.3) Transmission of Public Content

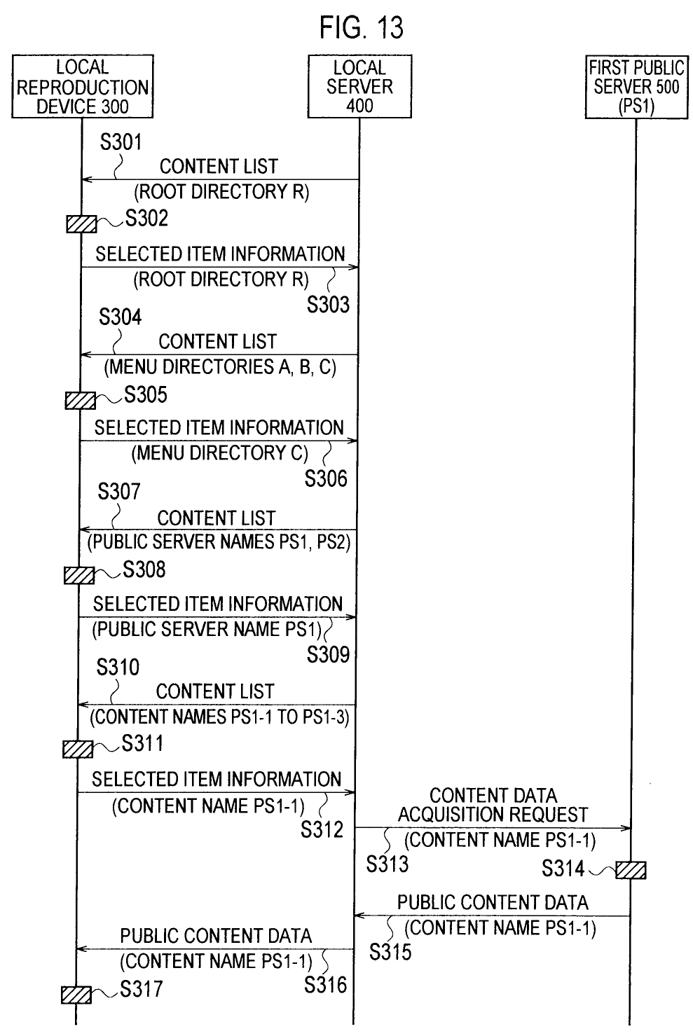

Next, operations of the content transmission system 1 from transmission of a content list to transmission of a public content list are described with reference to FIG. 13. FIG. 13 is a sequence diagram showing operations of the content transmission system 1 in the case where public content data is transmitted. Since the processing in step S301 to S305 in FIG. 13 is similar to that in step S201 to S205 in FIG. 12, the description of the processing is omitted.

In step S306, the local reproduction device 300 transmits selected item information indicating the menu directory C to local server 400.

In step S307, the local server 400 transmits a content list to the local reproduction device 300. Specifically, the local server 400 transmits the public server names PS1 and PS2 to the local reproduction device 300, the public server names PS1 and PS2 being the items included in the content list and located in the immediate lower tier of the menu directory C indicated by received selected item information.

In step S308, the local reproduction device 300 displays the received public server names PS1 and PS2.

In step S309, the local reproduction device 300 transmits selected item information indicating the public server name PS1 to the local server 400.

In step S310, the local server 400 transmits a content list to the local reproduction device 300. Specifically, the local server 400 transmits the content names PS1-1 to PS1-3 to the local reproduction device 300, the content names PS1-1 to PS1-3 being the items included in the content list and located in the immediate lower tier of the public server name PS1 indicated by received selected item information.

In step S311, the local reproduction device 300 displays the received content names PS1-1 to PS1-3.

In step S312, the local reproduction device 300 transmits selected item information indicating the content name PS1-1 to the local server 400.

In step S313, the local server 400 transmits a content data acquisition request to the public server 500, the content data acquisition request requesting acquisition of the content data corresponding to the content name PS1-1 indicated by received selected item information. Specifically, the local server 400 transmits a content data acquisition request to the first public server 500 corresponding to the public server name PS1 located in the immediate upper tier of the content name PS1-1, the content data acquisition request including the content name PS1-1 indicated by the received selected item information.

In step S314, the first public server 500 reads the content data. Specifically, the first public server 500 reads the public content data corresponding to the content name PS1-1 included in the received content data acquisition request.

In step S315, the first public server 500 transmits the read public content data to the local server 400.

In step S316, the local server 400 transmits received public content data to the local reproduction device 300.

In step S317, the local reproduction device 300 reproduces received public content data.

### (6) Operations and Effects

According to the content transmission system 1 of the first embodiment of the present invention, when the local server 400 receives a content list from the public server 500, the content list including the content names of the public content data stored in the public server 500, the local server 400 generates a content list that has the language format compatible with the local reproduction device 300 by converting the language format of the received content list. The local server 400 then transmits the generated content list to the local reproduction device 300.

According to such configuration, even if the content list acquired by the local reproduction device 300 is the one including a content name of the public content data stored in the public server 500, the local reproduction device 300 can display the content list in the display 350. Thus, the local reproduction device 300 can acquire public content data from the public server 500 connected to the public network 200.

### Other Embodiments

Although the invention has been disclosed through the embodiment according to the present invention as described above, it should be understood that the discussion and drawings which form a part of the disclosure are not intended to limit the invention. Various alternative embodiments, implementation examples, and application techniques will be apparent to those skilled in the art.

For example, although the first embodiment mentioned above is described for the case where one local reproduction device 300 is connected to the local network 100; however, the present invention is not limited to this case. For example, multiple local reproduction devices 300 may be connected to the local network 100. In this case, respective users of the multiple local reproduction devices 300 may assign different names to the public server 500.

In the first embodiment mentioned above, the local server 400 has been described in the case where a content list is generated when a content list acquisition request is received from the local reproduction device 300, but the present invention is not limited to this case. For example, the local server 400 may periodically generate (i.e., update) a content list and transmit the same to the local reproduction device 300.

In the first embodiment mentioned above, the invention is described in the case where the user of the local reproduction device 300 knows the address of the public server 500, and an address table which associates the public server name assigned by the user of the public server 500 with the address of the public server 500 is managed in the local server 400. However, the invention is not limited to this case. For example, a management device that manages multiple public servers 500 may be connected to the public network 200 so that an address table which associates a name assigned to each public server 500 by a user of the management device with the address of the public server 500 may be managed by the management device. In this case, a content list acquisition request, and a server name included in a content data acquisition request are inputted to the local reproduction device 300 based on an address table acquired from the management device.

Also, a program that causes a computer to execute the operations (i.e., the sequences shown in FIGS. 11 to 13) of the content transmission system 1 may be provided, for example. Also, a storage in which such program is stored may be provided. A storage in which the program is stored is, for example, a CD-ROM attached to each of the local reproduction device 300, the local server 400, and the public server 500.

In this manner, the present invention naturally includes various embodiments not specifically described herein. Accordingly, the technical scope of the present invention should be defined only by the specifications of the invention according to the claims based on the above description.

What is claimed is:

1. A local server connected to a local reproduction device via a local network and to a public server via a public network, the local server comprising:
a local communication unit configured to communicate with the local reproduction device via the local network;
a public communication unit configured to communicate with the public server via the public network; and
a converter configured to convert a language format compatible with the public server to another language format compatible with the local reproduction device, wherein
the local communication unit receives a list request from the local reproduction device, the list request requesting a list of content data stored in the public server;
the public communication unit receives the list of content data stored in the public server from the public server in response to the list request;
the converter converts the list of content data stored in the public server to a list of content data written in a language format compatible with the local reproduction device; and
the local communication unit transmits the resultant list of content data converted by the converter to the local reproduction device.

2. The local server according to claim 1, wherein
the local communication unit receives a content data request from the local reproduction device, the content data request requesting content data selected from the resultant list of content data converted by the converter,
the public communication unit receives content data from the public server in response to the content data request, the content data corresponding to the content data request, and
the local communication unit transmits the content data received from the public server to the local reproduction device.

3. The local server according to claim 1, wherein
the list of content data stored in the public server is written in a language format for which the local reproduction device has no display capability, and
the converter converts the list of content data stored in the public server and received from the public server by the public communication unit to a list of content data written in a language format for which the local reproduction device has display capability.

4. The local server according to claim 3, wherein
the list of content data stored in the public server and received from the public server by the public communication unit is written in a language format which is any one of HTML (Hyper Text Markup Language), XML (Extensible Markup Language), and JSON (JavaScript Object Notation), and
the converter converts the list of content data stored in the public server and received from the public server by the public communication unit to a list of content data written in a language format of CDS (Content Directory Service).

5. A content transmission method for a local server to transmit content data stored in a public server to a local reproduction device connected to the local server via a local network, the public server being connected to the local server via a public network, the content transmission method comprising the steps of:
transmitting a list request to the local server by the local reproduction device, the list request requesting a list of content data stored in the public server;
receiving a list of content data from the public server by the local server in response to the list request, the content data being stored in the public server;
converting the list of content data stored in the public server to a list of content data written in a language format compatible with the local reproduction device by the local server; and
transmitting the resultant list of content data converted in the step of converting to the local reproduction device by the local server.

6. The content transmission method according to claim 5, further comprising the steps of:
receiving a content data request from the local reproduction device by the local server, the content data request requesting content data selected from the resultant list of content data converted in the step of converting;
receiving content data from the public server by the local server in response to the content data request, the content data corresponding to the content data request; and
transmitting the content data received from the public server to the local reproduction device by the local server.

7. The content transmission method according to claim 5, wherein
the list of content data stored in the public server is written in a language format for which the local reproduction device has no display capability, and
in the step of converting, the list of content data stored in the public server and received from the public server is converted to a list of content data written in a language format for which the local reproduction device has display capability.

8. The content transmission method according to claim 7, wherein
the list of content data stored in the public server and received from the public server by the local server is written in a language format which is any one of HTML (Hyper Text Markup Language), XML (Extensible Markup Language), and JSON (JavaScript Object Notation), and
in the step of converting, the list of content data stored in the public server and received from the public server is converted to a list of content data written in a language format of CDS (Content Directory Service).
